(19) United States
(12) Patent Application Publication
(10) Pub. No.: US 2018/0063549 A1
(43) Pub. Date: Mar. 1, 2018

(54) SYSTEM AND METHOD FOR DYNAMICALLY CHANGING RESOLUTION BASED ON CONTENT

(71) Applicant: ATI Technologies ULC, Markham (CA)

(72) Inventors: Ihab Amer, Markham (CA); Gabor Sines, Markham (CA); Jinbo Qiu, Markham (CA); Yang Liu, Markham (CA); Haibo Liu, Markham (CA); Eren Gurses, Cupertino, CA (US)

(73) Assignee: ATI Technologies ULC, Markham (CA)

(21) Appl. No.: 15/246,503

(22) Filed: Aug. 24, 2016

(51) Int. Cl. H04N 19/59; H04N 19/172; H04N 19/126; H04N 19/51; H04N 19/30

(52) U.S. Cl. CPC H04N 19/59; H04N 19/172; H04N 19/30; H04N 19/51; H04N 19/126

(57) ABSTRACT

Described is a system and method for dynamically changing a resolution level at a frame level based on runtime pre-encoding analysis of content in a video stream. A video encoder continuously analyzes the content during runtime, and collects statistics and/or characteristics of the content before encoding it. This classifies the frame among pre-defined categories of content, where every category has its own bitrate/resolution relation. The runtime encoding resolution is dynamically dependent on the target bitrate and the collected statistics and/or characteristics of the content. This achieves a high quality encode for sequences that are composed of scenes with various content complexity levels for different frames in the video streams.

### BACKGROUND

The transmission and reception of video data over various media is ever increasing. Video encoders are typically used to compress the video data and reduce the amount of video data transmitted over the particular medium. Rate control is a process that takes place during video encoding to maximize the quality of the encoded video, while adhering to the target bitrate constraints. Typically, the Quantization Parameter (QP) is the only parameter that is used by the video encoder to adapt to the varying content or available bitrate. Changing the QP has an impact on the fidelity and quality of the encoded content, since a higher QP means a greater loss of details during the quantization process. Existing studies show that sometimes, encoding a lower resolution version of the content at a low QP value meets the bandwidth constraints with less subjective quality drops compared to aggressively raising the QP while keeping a higher resolution. The existing studies also show that, every “type” of content has its own bitrate point where dropping the resolution shows better quality benefits than raising the QP while preserving the resolution.

### BRIEF DESCRIPTION OF THE DRAWINGS

A more detailed understanding may be had from the following description, given by way of example in conjunction with the accompanying drawings wherein:

FIG. 1 is a high level block diagram of a system that uses a video encoder in accordance with certain implementations;

FIG. 2 is a graph illustrating that at certain bitrates encoding lower resolution of content provides better quality than preserving the higher resolution;

FIG. 3 is an illustration of dynamically changing a resolution level at a frame level in accordance with certain implementations;

FIG. 4 is an example flow diagram for dynamically changing a resolution level at a frame level in accordance with certain implementations; and

FIG. 5 is a block diagram of an example device in which one or more disclosed implementations may be implemented.

### DETAILED DESCRIPTION

Existing methods can be categorized as either: 1) algorithms that select the encoding resolution from a universal static table based on the available network bandwidth, and then use a Quantization Parameter (QP) to react to variations in content; and 2) algorithms that select the encoding resolution from tables based on the available network bandwidth, where the tables are prepared offline and are customized to the specific content. Both of these methods have disadvantages.

With respect to the first method, each type of content has a point where switching to a lower resolution is more beneficial. Using a universal table of resolution versus network bandwidth is a one-size-fit-all approach that will lead to highly compressible content (e.g., cartoons) suffering from the constraints of the least compressible content (e.g., highly complex or active noisy content). Although the second method addresses the negative issues of using the first method, the second method requires pre-awareness of the content being encoded. Hence, it is more suitable for offline encoding usage scenarios such as video-on-demand services. However, the second method fails with respect to real-time scenarios such as camera-captured streaming/broadcasting, due to the lack of information about the encoded content. Moreover, such methods assume that the behavior of a video stream is relatively stable/constant over time, and disregards the fact that there are streams that are composed of different scenes with different levels of complexity.

Described are a system and method for dynamically changing a resolution level at a frame level based on runtime pre-encoding analysis of content in a video stream or sequence. A video encoder continuously analyzes the content in runtime, (e.g., each frame or as encoding is taking place), and collects statistics of the content before encoding it. This assists in classifying the frame among pre-defined categories of content, where every category has its own bitrate and resolution relation. The runtime encoding resolution dynamically depends on the target estimated bitrate of the video stream and the collected statistics of the content. This achieves a high quality encoding for sequences that are composed of scenes with various content complexity levels. That is, better encoding resolution is achieved for content that varies on a frame-by-frame or time basis for the video stream.

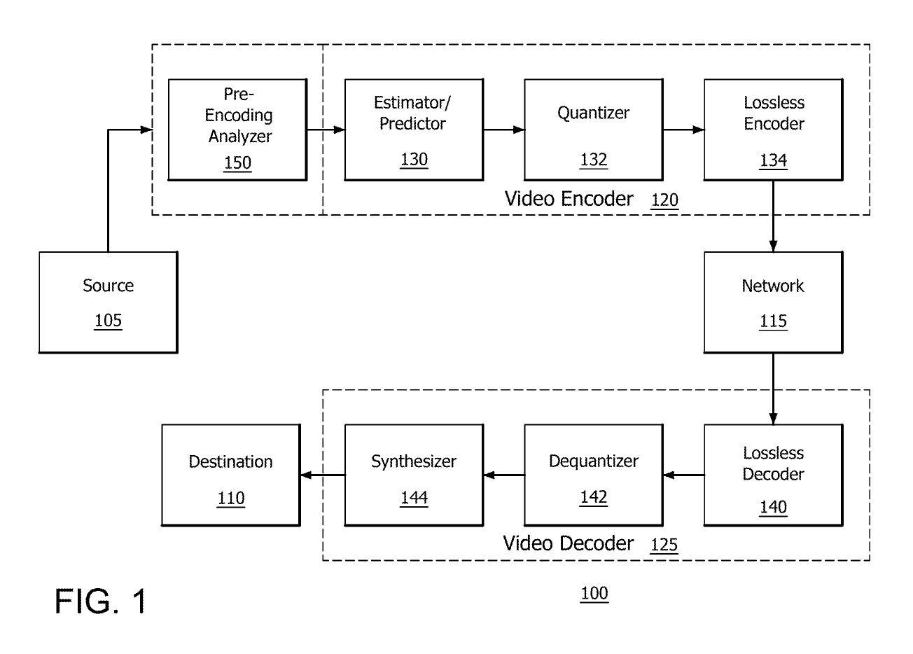

FIG. 1 is a high level block diagram of a system 100 that uses video encoders as described herein below to send encoded video data or video streams over a network 115 from a source side 105 to a destination side 110 in accordance with certain implementations. The source side 105 includes any device capable of storing, capturing or generating video data that may be transmitted to the destination side 110. The device can be, but is not limited to, a mobile phone, an online gaming device, a camera or a multimedia server. The video stream from these devices feeds video encoder(s) 120, which in turn encodes the video stream as described herein below. The encoded video stream is processed by video decoder(s) 125, which in turn sends the decoded video stream to destination devices, which can be, but is not limited to, an online gaming device and a display monitor.

The video encoder 120 includes, but is not limited to, an estimator/predictor 130, a quantizer 132 and a lossless encoder 134. The video decoder 125 includes, but is not limited to, a lossless decoder 140, a dequantizer 142 and a synthesizer 144. For example, in some implementations, the lossless encoder 134 and the lossless decoder 140 can be replaced by a lossy encoder and a lossy decoder respectively.

In general, video encoding decreases the amount of bits required to encode a sequence of rendered video frames by eliminating redundant image information. For example, closely adjacent video frames in a sequence of video frames are usually very similar and often only differ in that one or more objects in the scenes they depict move slightly between the sequential frames. The estimator/predictor 130 is configured to exploit this temporal redundancy between video frames by searching a reference video frame for a block of pixels that closely matches a block of pixels in a current video frame to be encoded. The video encoder 120 implements rate control by determining and selecting a Quantization Parameter (QP). The quantizer 132 uses the QP to adapt to the varying content and/or available bitrate. The lossless encoder 134 compresses the estimated/predicted and quantized (i.e. rate controlled) video stream prior to transmission over the network 115. The lossless decoder 140 decompresses the video stream received via the network 115. The dequantizer 142 processes the decompressed video stream and the synthesizer 144 reconstructs the video stream before transmitting it to the destination 110.

Typically, the QP is the only parameter that is used by the video encoder 120 to adapt to the varying content and/or available bitrate. Changing QP has its impact on the fidelity or quality of the encoded content, since higher QPs mean greater loss of details during the quantization process. The described video encoder 120 resolves this issue by implementing a pre-encoding analyzer 150 which functions as described herein below. In an implementation, the pre-encoding analyzer 150 is integrated with the video encoder 120. In an alternative implementation, the pre-encoding analyzer 150 is a standalone device.

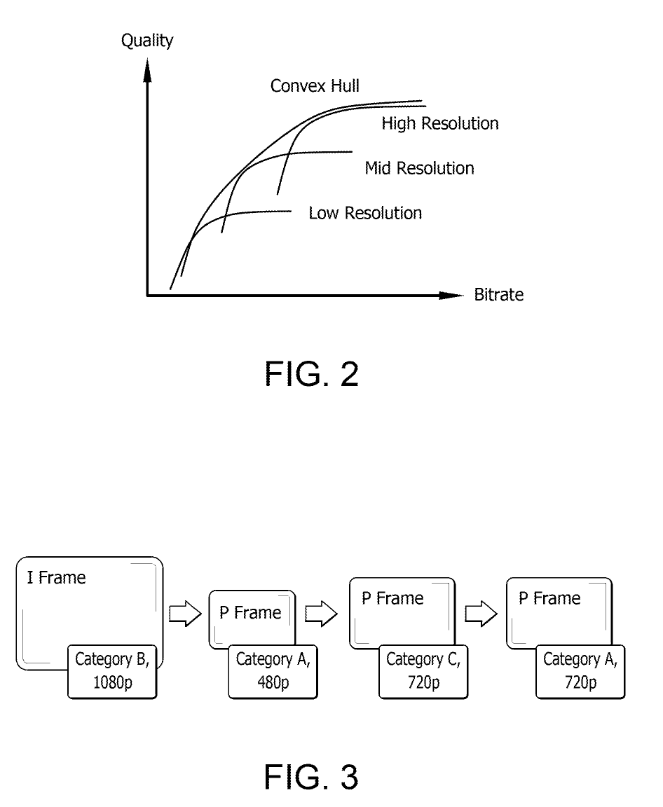

As state herein above, each category of content has a specific resolution and bitrate relationship. As illustrated in FIG. 2, each resolution has a bitrate region in which it outperforms other resolutions. A boundary line, (identified as a convex hull), denotes an encoding point where it is difficult to make any one feature, characteristic, or statistic, (hereinafter “statistic”), better off without making at least one statistic worse off. Consequently, operating at the convex hull is ideal but not practical. An implementation of the video encoder 120 instead selects a bitrate and resolution relation from tables that are based on content categorization, where each table operates near the convex hull. Once the table is selected, the target bitrate of the video frame is used to determine the proper resolution. For example, Tables 1-3 represent bitrate and resolution relationships for categories A, B and C, where A, B and C can represent cartoons, action movies and dramas.

TABLE 1

| Bitrate | Resolution |
|---|---|
| 300 | 240p |
| 1000 | 480p |
| 2000 | 720p |
| 4000 | 1080p |
| 6000 | 4k |

TABLE 2

| Bitrate | Resolution |
|---|---|
| 400 | 240p |
| 1500 | 480p |
| 3000 | 720p |
| 5000 | 1080p |
| 7000 | 4k |

TABLE 3

| Bitrate | Resolution |
|---|---|
| 500 | 240p |
| 2000 | 480p |
| 4000 | 720p |
| 6000 | 1080p |
| 8000 | 4k |

In addition to storing the bitrate and resolution relation for each category, statistics are stored for each category. These statistics include, but are not limited to, one or more of the following: motion, spatial relationship, level of motion, and variance of motion or spatial relationships. In an implementation, an offline exhaustive machine learning process is used to determine a best mode of operation (scale or no-scale), as a function of at least resolution, variance, motion, and target bitrate. The results of the machine learning process are mapped or grouped into a set of categories.

In general, the pre-encoding analyzer 150 analyzes the content before encoding it, and then maps the statistics collected from the content to one of a plurality of pre-defined categories of content based on collected statistics. That is, at the beginning of the encoding process, prior to compressing a frame, the content of the frame is analyzed to collect certain statistics. These statistics are compared against the stored statistics for categories A, B, . . . N, to choose one of them as representative of this frame. Once the category is chosen, the target bitrate is used to determine the proper resolution level. The pre-encoding analyzer 150 dynamically changes the resolution versus bandwidth table used during runtime, adapting to variation in content complexity.

FIG. 3 illustrates an example of this frame-by-frame, dynamic selection process. For the specific frames shown, the appropriate resolution is selected based on the table of the corresponding category, and the resolution is dynamically changed as required. For example, for the I frame, the video encoder 100 determines that the content is category B and selects 1080p as the resolution. The selected resolution in each case is based on a target average bitrate for the video sequence or stream. For the first P frame, the pre-encoding analyzer 150 determines that the content is category A and selects 480p as the resolution. For the second P frame, the video encoder 100 determines that the content is category C and selects 720p as the resolution. For the last P frame, the video encoder 100 determines that the content is category A and selects 720p as the resolution.

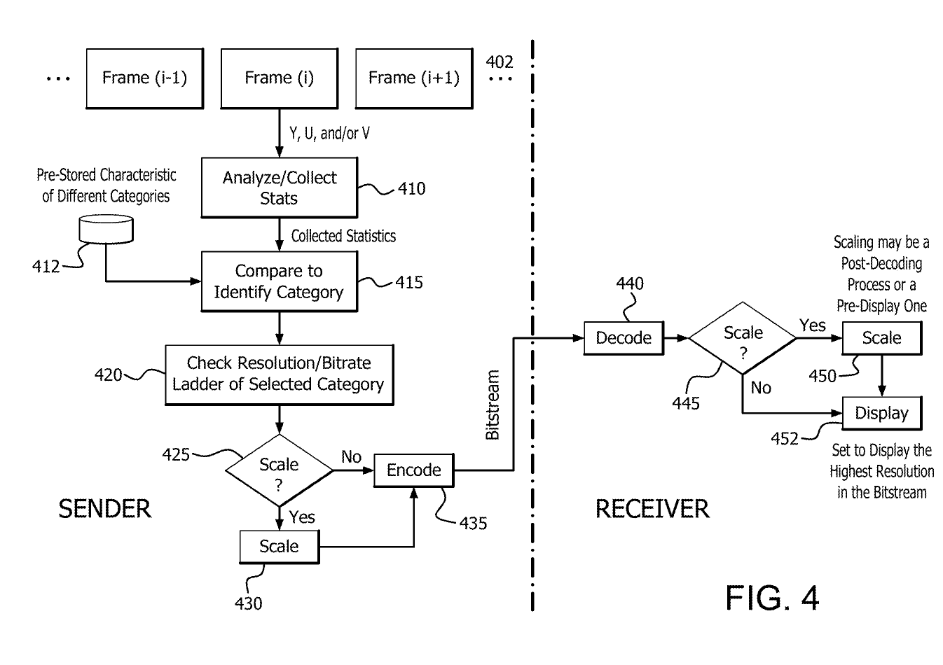

FIG. 4 is an example flow diagram 400 for dynamically changing a resolution level at a frame level in accordance with certain implementations and is performed by the pre-encoding analyzer 150 of FIG. 1. A video stream 402 is received by the pre-encoding analyzer 150 (410) and includes a plurality of video frames. During runtime, the content of a video frame from the video stream 402 is analyzed and a set of statistics is collected. The statistics are then compared against a set of pre-stored statistics 412 that are associated with different content categories (415) for the video frame. These pre-stored statistics for different content categories is performed offline. In another implementation, the pre-stored statistics can be updated. The resolution and bitrate tables are checked for the determined category for the video frame, a resolution level is selected based on the target estimated bitrate and a resolution change is done dynamically and during runtime as needed (420). A determination is then made as to whether scaling, upscaling or downscaling, needs to be performed on the video frame (425). If scaling is needed (Yes), then scaling, upscaling or downscaling, is performed on the video frame (430). If scaling is not needed (No) and after scaling is performed when needed, then the video frame is processed by the estimator/predictor 130, a quantizer 132, a lossless encoder 134 and transmitted to a receiver.

On the receiver side, the encoded video frame is decoded (440) by a decoder 125 and then a determination is made as to whether scaling needs to be performed on the decoded video frame (445). If scaling is needed (Yes), then scaling, (upscaling or downscaling), is performed on the decoded video frame (450). If scaling is not needed (No), or after scaling is performed when needed, then the decoded video frame is displayed on a display 452, for example. The above process is repeated for every video frame in the video sequence. That is, the encoding resolution is performed during runtime and is dynamically dependent on the target bitrate and the collected statistics of the content.

As shown, scaling can be done on both the sender side and the receiver side. At the receiver side, after the pictures are decoded, scaling up to a target size can happen inside the decoder (out of loop) or as part of a final compositor or presenter step (not shown). Encoding artifacts are typically more annoying and visible than blurring introduced by downscaling (before encoding) and then upscaling at the receiver side.

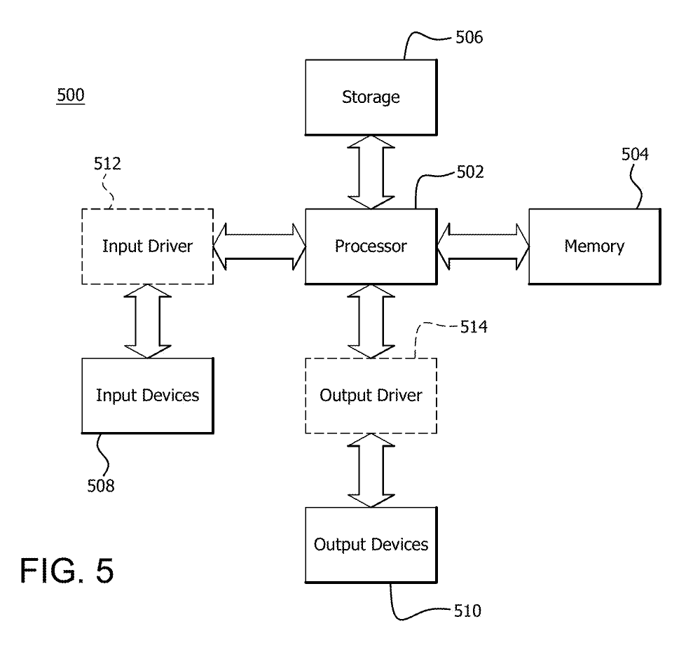

FIG. 5 is a block diagram of an example device 500 in which one or more portions of one or more disclosed embodiments may be implemented. The device 500 may include, for example, a head mounted device, a server, a computer, a gaming device, a handheld device, a set-top box, a television, a mobile phone, or a tablet computer. The device 500 includes a processor 502, a memory 504, a storage 506, one or more input devices 508, and one or more output devices 510. The device 500 may also optionally include an input driver 512 and an output driver 514. It is understood that the device 500 may include additional components not shown in FIG. 5.

The processor 502 may include a central processing unit (CPU), a graphics processing unit (GPU), a CPU and GPU located on the same die, or one or more processor cores, wherein each processor core may be a CPU or a GPU. The memory 504 may be located on the same die as the processor 502, or may be located separately from the processor 502. The memory 504 may include a volatile or non-volatile memory, for example, random access memory (RAM), dynamic RAM, or a cache.

The storage 506 may include a fixed or removable storage, for example, a hard disk drive, a solid state drive, an optical disk, or a flash drive. The input devices 508 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 510 may include a display, a speaker, a printer, a haptic feedback device, one or more lights, an antenna, or a network connection (e.g., a wireless local area network card for transmission and/or reception of wireless IEEE 802 signals).

The input driver 512 communicates with the processor 502 and the input devices 508, and permits the processor 502 to receive input from the input devices 508. The output driver 514 communicates with the processor 502 and the output devices 510, and permits the processor 502 to send output to the output devices 510. It is noted that the input driver 512 and the output driver 514 are optional components, and that the device 500 will operate in the same manner if the input driver 512 and the output driver 514 are not present.

In an implementation, a method for dynamically changing resolution based on content is described. The method collects statistics for each frame in a video stream during runtime, selects for each frame a resolution level based on a content category for the collected statistics and a target estimated bitrate for the video stream, and dynamically changes during runtime each frame resolution to the selected resolution level as needed. In an implementation, the method further determines the content category for each frame by comparing the collected statistics against pre-stored statistics. In an implementation, the statistics include at least one of motion, spatial relationship, level of motion, and variance of motion and/or spatial relationship. In an implementation, the pre-stored statistics for each content category is collected offline. In an implementation, the pre-stored statistics for each content category is updated during runtime. In an implementation, the method scales the frame after an appropriate resolution level is set for the frame. In an implementation, the scaling is one of upscaling or downscaling.

In an implementation, an encoding system includes a pre-encoder and an encoder. The pre-encoder collects statistics for each video frame in a video stream during runtime, selects for each video frame a resolution level based on a content category for the collected statistics and a target estimated bitrate for the video stream and dynamically changes, during runtime, each video frame's resolution to the selected resolution level as needed. The encoder compresses the video frame. In an implementation, the pre-encoder determines the content category for each video frame by comparing the collected statistics against pre-stored statistics. In an implementation, the statistics include at least one of motion, spatial relationship, level of motion, and variance of motion and/or spatial relationship. In an implementation, the pre-stored statistics for each content category is collected offline. In an implementation, the pre-stored statistics for each content category is updated during runtime. In an implementation, the encoder scales the video frame after an appropriate resolution level is set for the video frame. In an implementation, the scaling is one of upscaling or downscaling.

In an implementation, a method for dynamically changing resolution based on content is described. The method collects statistics frame-by-frame from a video stream, selects, frame-by-frame, a resolution level based on a determined content category for the collected statistics and a target estimated bitrate for the video stream and dynamically changes, frame-by-frame, during runtime to the selected resolution level as needed. In an implementation, the method determines the content category frame-by-frame by comparing the collected statistics against pre-stored statistics. In an implementation, the statistics include at least one of motion, spatial relationship, level of motion, and variance of motion and/or spatial relationship. In an implementation, the pre-stored statistics for each content category is collected offline. In an implementation, the method scales frame-by-frame after an appropriate resolution level is set. In an implementation, the scaling is one of upscaling or downscaling.

In general and without limiting implementations described herein, a computer readable non-transitory medium including instructions which when executed in a processing system cause the processing system to execute a method for dynamically changing a resolution level based on content as described herein.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the implementations.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for dynamically changing resolution based on content, the method comprising:
collecting statistics for each frame in a video stream during runtime;
selecting for each frame a resolution level based on a content category for the collected statistics and a target estimated bitrate for the video stream; and
dynamically changing during runtime each frame resolution to the selected resolution level as needed.

2. The method of claim 1, further comprising:
determining the content category for each frame by comparing the collected statistics against pre-stored statistics.

3. The method of claim 1, wherein the statistics include at least one of motion, spatial relationship, level of motion, and variance of motion and/or spatial relationship.

4. The method of claim 2, wherein the pre-stored statistics for each content category is collected offline.

5. The method of claim 2, wherein the pre-stored statistics for each content category is updated during runtime.

6. The method of claim 1, further comprising:
scaling the frame after an appropriate resolution level is set for the frame.

7. The method of claim 1, wherein the scaling is one of upscaling or downscaling.

8. An encoding system comprising:
a pre-encoder configured to:
collect statistics for each video frame in a video stream during runtime;
select for each video frame a resolution level based on a content category for the collected statistics and a target estimated bitrate for the video stream; and
dynamically change, during runtime, each video frame's resolution to the selected resolution level as needed; and
an encoder configured to compress the video frame.

9. The encoding system of claim 8, wherein the pre-encoder is configured to determine the content category for each video frame by comparing the collected statistics against pre-stored statistics.

10. The encoding system of claim 8, wherein the statistics include at least one of motion, spatial relationship, level of motion, and variance of motion and/or spatial relationship.

11. The encoding system of claim 9, wherein the pre-stored statistics for each content category is collected offline.

12. The encoding system of claim 9, wherein the pre-stored statistics for each content category is updated during runtime.

13. The encoding system of claim 9, wherein the encoder is configured to scale the video frame after an appropriate resolution level is set for the video frame.

14. The encoding system of claim 13, wherein the scaling is one of upscaling or downscaling.

15. A method for dynamically changing resolution based on content, the method comprising:
collecting statistics frame-by-frame from a video stream;
selecting, frame-by-frame, a resolution level based on a determined content category for the collected statistics and a target estimated bitrate for the video stream; and
dynamically changing, frame-by-frame, during runtime to the selected resolution level as needed.

16. The method of claim 15, further comprising:
determining the content category frame-by-frame by comparing the collected statistics against pre-stored statistics.

17. The method of claim 15, wherein the statistics include at least one of motion, spatial relationship, level of motion, and variance of motion and/or spatial relationship.

18. The method of claim 16, wherein the pre-stored statistics for each content category is collected offline.

19. The method of claim 15, further comprising:
scaling frame-by-frame after an appropriate resolution level is set.

20. The method of claim 19, wherein the scaling is one of upscaling or downscaling.
